(19) United States
(12) Patent Application Publication
(10) Pub. No.: US 2026/0101272 A1
(43) Pub. Date: Apr. 9, 2026

(54) Methods for VFL Configuration Coordination

(71) Applicant: InterDigital Patent Holdings, Inc., Wilmington, DE (US)

(72) Inventors: Jung Je Son, Warrington, PA (US); Ulises Olvera-Hernandez, Saint-Lazare (CA); Michel Roy, Candiac (CA); Zhibi Wang, Woodridge, IL (US); Achref Methenni, Montreal (CA); Guanzhou Wang, Brossard (CA)

(73) Assignee: InterDigital Patent Holdings, Inc., Wilmington, DE (US)

(21) Appl. No.: 18/905,881

(22) Filed: Oct. 3, 2024

(51) Int. Cl. H04W 48/16; H04L 41/14; H04W 48/18; H04W 60/04

(52) U.S. Cl. CPC H04W 48/16; H04L 41/14; H04W 48/18; H04W 60/04

(57) ABSTRACT

A vertical federated learning (VFL) server may send a discovery request to a network repository function (NRF). The VFL server may send a discovery request to a network repository function (NRF). The discovery request may comprise a VFL configuration identifier (ID). The VFL configuration ID may be supported by the VFL server. The discovery request may indicate that the VFL server is configured to discover one or more VFL clients. The one or more VFL clients may support the VFL configuration ID. The VFL server may receive a discovery response. The discovery response may comprise a list of one or more VFL clients that support the VFL configuration ID. The WTRU may select one or more VFL clients from the list of VFL clients. The WTRU may perform sample alignment on the selected one or more VFL clients.

### BACKGROUND

The Network Data Analytics service may provide statistics and/or predictions based on specific requests from entities that consume different statistics and/or predictions. Information the Network Data Analytics service provides may include statistics and/or predictions on gNB status information, gNB resource usage, and/or communication and/or mobility performance in an area of interest. The target of such analytics may comprise of a single user equipment (UE), also known as a wireless transmit/receive unit (WTRU), a group of WTRUs and/or any WTRU that may be in an area of interest. The Network Data Analytics service may provide analysis on statistics and/or predictions regarding WTRU mobility, expected WTRU behavior, and/or observed service experience at multiple levels (e.g., per network slice, per application, and/or per access type, etc.).

### SUMMARY

A vertical federated learning (VFL) server may send a discovery request to a network repository function (NRF). The VFL server may send a discovery request to a network repository function (NRF). The discovery request may comprise a VFL configuration identifier (ID). The VFL configuration ID may be supported by the VFL server. The discovery request may indicate that the VFL server is configured to discover one or more VFL clients. The one or more VFL clients may support the VFL configuration ID. The VFL server may receive a discovery response. The discovery response may comprise a list of one or more VFL clients that support the VFL configuration ID. The WTRU may select one or more VFL clients from the list of VFL clients. The WTRU may perform sample alignment on the selected one or more VFL clients.

The VFL server may send a capability registration request to the NRF. The capability registration request may comprise the VFL configuration ID and/or one or more network function (NF) types supported by the VFL server. The VFL server may receive, from the NRF, a confirmation of receipt of the capability registration request. The capability registration request may further comprise an indication of the VFL server being capable of performing as a network data analytic function (NWDAF) or as an application function (AF).

The VFL server may determine the VFL configuration ID based on an analytic ID and/or a machine learning (ML) model. The VLF configuration ID may be further based on one or more of a single network slice selection assistance information (S-NSSAI), an area of interest of network communication, and/or an area of interest of network communication mobility. The analytic ID may be associated with the service area covered by the VFL client.

The VFL server may receive, prior to sending the discovery request to the NRF, a request to select one or more VFL clients associated with the analytic ID supported by the VFL server.

The VFL server may perform machine learning model training with the selected VFL clients based on the VFL configuration ID. The selection of VFL clients may be further based on one or more of network function (NF) types associated with the VFL server, service area of the network, resource utilization ratio, and/or power consumption ratio. The VFL server may select, based on the sample alignment result, a different set of one or more VFL clients from the list of one or more VFL clients that support the VFL configuration ID.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a callflow of a vertical federated learning (VFL) procedure with VFL clients using a VFL configuration identifier (ID).

FIG. 3 depicts a callflow of a VFL procedure with an application function (AF) as a VFL server using VFL configuration ID.

### DETAILED DESCRIPTION

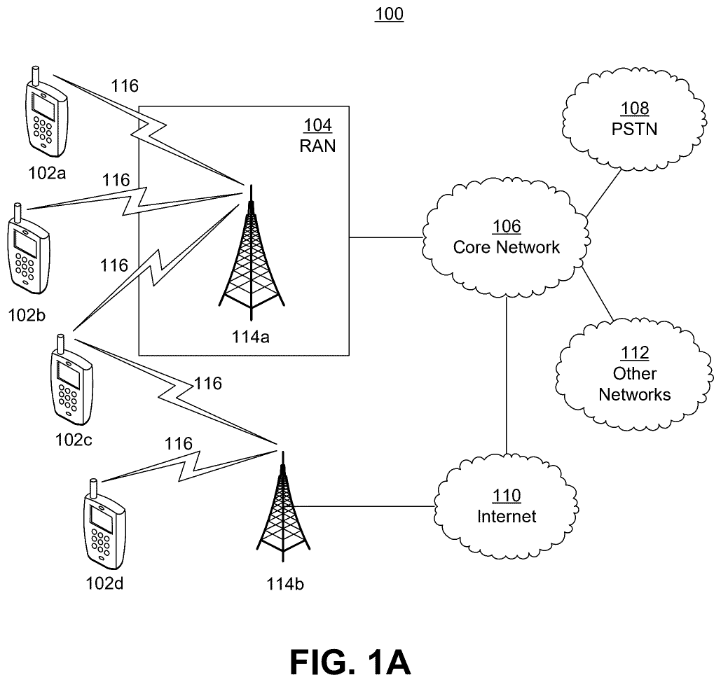

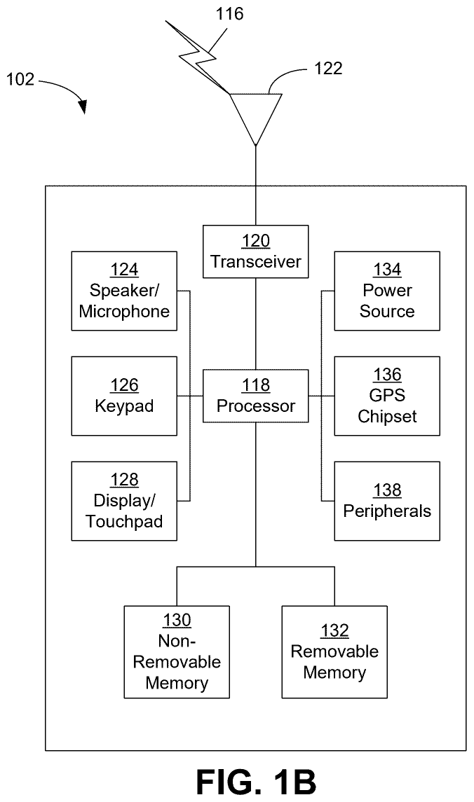

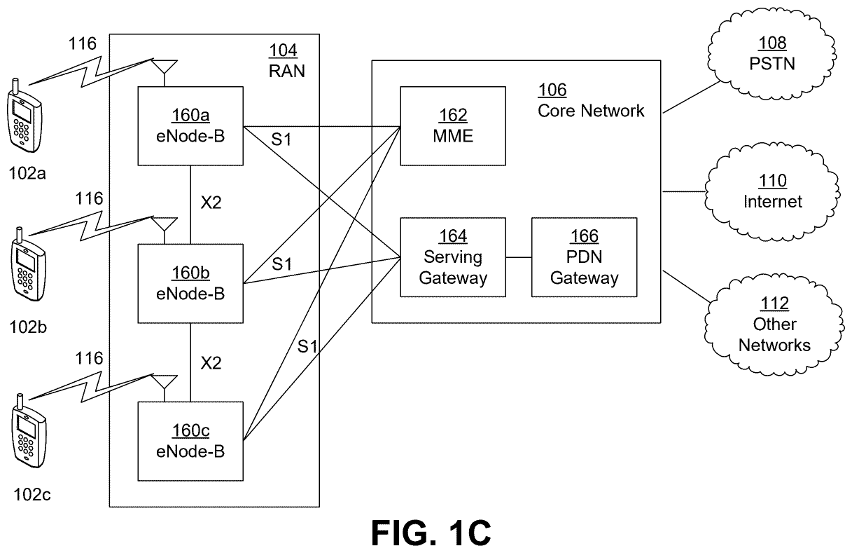

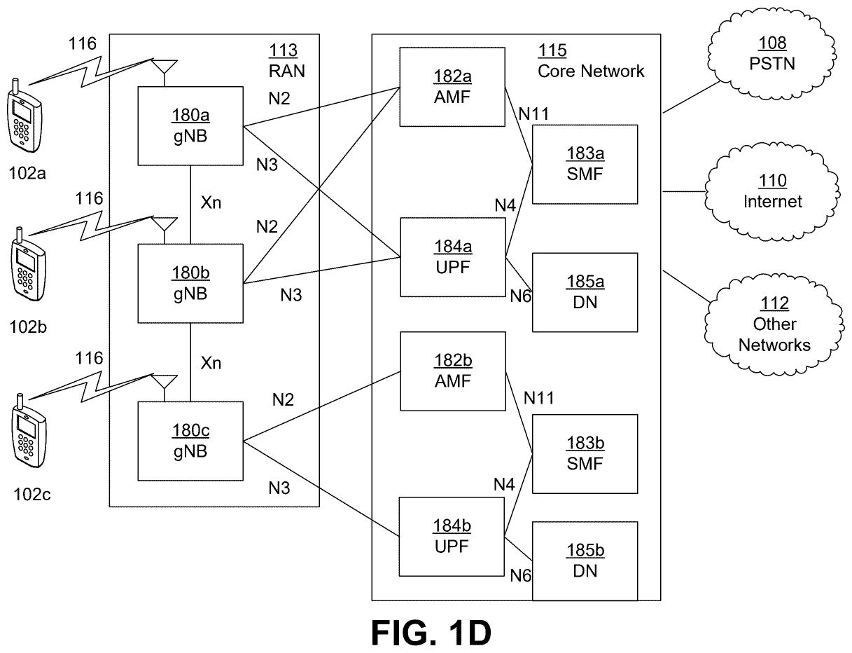

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (loT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUS 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

For vertical federated learning (VFL) model configuration negotiation, a VFL server and/or VFL clients may register supported VFL configuration ID(s) per analytic ID. Discovery of VFL clients may be based on VFL configuration ID and/or network function (NF) types as a data source. The VFL server may perform sample alignment and/or machine learning (ML) model training with selected VFL clients as configured by VFL configuration ID.

The Network Data Analytics service may be provided by a NWDAF (network data analytics function) in 5GC. The NWDAF may register to a network repository function (NRF) its supported analytics identifier (ID), possibly per service. This analytics ID may indicate a kind of network data analytics service, such as slice load level related network data analytics, observed service experience related network data analytics, and/or federated learning amongst multiple NWDAFs, etc.

The NWDAF may contain an analytics logical function (AnLF). The AnLF may be a logical function in NWDAF which performs inference, derives analytics information (e.g., derives statistics and/or predictions based on analytics consumer request), and/or exposes analytics service. The NWDAF may further contain a model training logical function (MTLF). The MTLF may be a logical function in NWDAF which trains machine learning (ML) models and/or exposes new training services (e.g. providing trained ML model). The NWDAF (e.g., the MTLF) may provide trained ML Models to the AnLF. The NWDAF may decide whether to use horizontal and/or vertical federated learning for training ML models.

Vertical federated learning (VFL) is a machine learning technique without exchanging and/or sharing local data set. The VFL may operate while maintaining a level of coordination amongst VFL participants. When training and/or inference are performed on local machine learning (ML) models, the local data set in different VFL participants for local model training may have different feature spaces for the same samples (e.g. WTRU IDs). VFL may involve multiple NWDAFs and/or AFs.

A feature space may use a ML model that is specific to that feature space and may require a data set that is also specific to the feature space and to the ML model used in the feature space.

Different feature spaces may be used when performing VFL. Each feature space may use a different ML model that is feature space specific. Consequently, each feature space may require a feature space specific data set.

Sample alignment may be performed between the feature spaces. The sample alignment may determine common attributes to be considered while performing VFL in the different feature spaces. For example, if VFL is performed in a mobile network, each feature space may perform in VFL using its own ML models and/or data sets for a specific group of WTRUs. Thus a sample alignment on WTRU identifiers may be needed. Other examples of sample alignment may include a time period, geographical location(s), a determined portion of a network (e.g., list of TAs), and/pr functional element(s) of a network (e.g., an AMF, a SMF, and/or a list of UPF, etc.). Accordingly, the sample alignment information may be communicated to each feature space and/or each feature space may consider sample alignment information to determine the data set for performing VFL. For VFL, there may be one NWDAF and/or one AF acting as a VFL server and/or one or multiple NWDAF(s) and/or one or multiple AF(s) acting as VFL client(s).

The VFL server and/or VFL client may may perform one or more functionalities. For example, the VFL server may discover and/or select VFL client(s) (e.g., NWDAF(s) and/or AF(s)) to participate in a VFL procedure. The VFL server may request VFL clients to do local ML model training for an Analytic ID. The VFL server may aggregate intermediate results from VFL client(s). The VFL server may compute intermediate training results (e.g. gradient information and/or loss information) for updating its own local ML model and/or the ML models of VFL clients during the VFL training process. The VFL server may send the intermediate training results towards VFL clients involved in the joint VFL training process. The VFL server may initiate the VFL inference process using VFL model correlation ID. The VFL server may aggregate local inference result from VFL clients and/or generate the final VFL inference result. The VFL server may send the final VFL inference result to the consumer.

A VFL client may locally train a ML model with the available local data set. The local data set may include the data that may not be shared with other VFL clients due to data privacy, data security, and/or data access rights, etc. The VFL client may compute the intermediate results for their local ML models involved in the VFL training and/or provide reports with the intermediate results to the AF and/or NWDAF acting as VFL server. The VFL client may perform inference based on the local model and/or local data. The VFL client may provide inference results to VFL server.

VFL is a federated learning method which performs joint training without exposing raw data. Each entity involved in the VFL operation may owning its own ML model. For VFL, multiple parties perform training on data sets that share the same sample space but differ in feature space. Because of this characteristic, an alignment in sample and/or feature spaces among participating entities is usually required before applying VFL.

As an example, 5GC may provide observed service experience analytics by using VFL procedures. For observed service experience analytics service by NWDAF, for each WTRU included in the procedure, data needs to be collected from various sources. For example, service quality and/or service experience data are needed from an AF as input data, network data in a quality of service (QoS) flow level is needed from 5GC NF as input data, and/or WTRU level network data relating to the QoS profile is needed from operations, administration, and management system (OAM).

When a NWDAF and/or an AF initiates VFL training process for observed service experience analytics, it may be desired that no exchange of raw data take place directly between the NWDAF and an external AF. The NWDAF may be in the public land mobile network (PLMN) and/or the AF may be outside the PLMN. Accordingly, these conditions may compromise user data which has high privacy protection requirements.

The NWDAF and/or the AF may have different features of the same sample identity for local training. For example, the NWDAF(s) and the AF may make alignment of samples and/or features for jointly working for federated learning.

Additionally, when NWDAFs from different vendors are involved together for VFL, for each feature, there shall be alignments among NWDAFs. These alignments provide how the features are defined, measured, and/or presented. The VFL server also may coordinate these alignments because VFL server needs to aggregate the results from VFL clients corresponding to different vendors and/or apply the results to learn global ML model.

The NWDAF as a VFL server may register its capability as VFL server with supported analytic ID and/or supported VFL configuration ID per supported analytic ID. When VFL operation is triggered, the VFL server may determine VFL configuration for the VFL operation per analytic ID, represented by VFL configuration ID. The VFL server may send a discovery request to NRF to discover VFL clients supporting the VFL configuration ID. The VFL server may receive discovery response from NRF. The discovery response may include a list of VFL clients with associated NF types as a data source. The VFL server may select from a list of VFL clients for VFL operation with VFL configuration represented VFL configuration ID. The VFL server may then perform sample alignment with selected VFL clients. Moreover, the VFL server may perform ML model training procedure with selected VFL client per VFL configuration ID.

For VFL operation, the VFL server may play one or more crucial roles in coordinating ML model training of VFL clients. Such a roles may include sample alignment, intermediate result exchange, model update, and/or privacy and security, etc.

For VFL coordination, the VFL server may be aware of the ML model supported by VFL clients. When aware of the ML model supported by VFL clients, the VFL server may discover and/or select proper VFL clients for VFL coordination and/or optimization (e.g., aggregate intermediate result and/or update ML models), supporting model compatibility among different VFL clients, and/or privacy and/or security.

When using VFL to derive network data analytics, the VFL server may be aware of the supported ML model per analytic ID by VFL clients as VFL may involve different entities from different domains involved for VFL (e.g., NWDAF and/or AF). Therefore, when a VFL server discovers VFL clients, the VFL server may consider the ML model supported by the VFL client(s).

For each analytic service represented by analytic ID, the VFL server may utilize a different VFL configurations for different ML models. A VFL server may verify if the discovered VFL clients support the ML models and/or different VFL configurations. For example, a basic VFL client may support only preconfigured and/or static ML models and configurations. However, an evolved VFL client may support ML models dynamically obtained from a VFL server and/or may support configuration capabilities for input features, output features, and/or associated data providers.

A VFL server may also consider how VFL clients support the features used by VFL configuration. For example, NWDAF from different vendors may have different definitions, different granularities, and/or different formats per feature. For alignment of supported ML model between VFL server and VFL clients, the entities may need to exchange additional information of supported ML models to guarantee the compatibility of supported ML model with features. There may be a need to define a common solution for supporting different deployments, use cases, and/or equipment of mobile networks.

Providing common and/or efficient mechanisms to allow a VFL server to discover and/or select VFL clients according to the VFL's client(s)'s VFL configuration and/or ML model capabilities may be critical. But it will be quite difficult problem to solve as there may be many different definitions and formats available.

As discussed herein, the mobile network may enable VFL operation that supports efficient discovery and/or selection of VFL clients for a requested VFL configuration and/or ML model.

In VFL operations, different VFL configurations may exist for an analytic ID. For example, a VFL client may support ML models dynamically obtained from a VFL server. The VFL client may support configuration capabilities for input features, output features, and/or associated data providers.

A VFL configuration may determine how VFL is composed between VFL server and/or VFL clients. The VFL configuration may determine how VFL servers and/or VFL clients jointly perform VFL. A VFL configuration may specify how many local ML models are needed, how each local ML model is composed of input features and/or output features, and/or how outputs of local ML models integrate into the ML model at VFL servers, etc.

In an operator domain, when VFL for an analytic ID is implemented with a specific VFL configuration, the operator may register and/or manage the VFL configuration. A VFL configuration ID per analytic ID may be assigned to the registered VFL configuration. The analytic ID itself may serve and/or be used as the configuration ID when one VFL configuration is available and/or used for an analytic ID.

Additionally or alternatively, a VFL configuration ID may be assigned for each VFL configuration per analytic ID and/or ML model. When the analytic ID is used as the configuration ID, the analytic ID may also be associated to specific ML models.

Different VFL servers and/or VFL client entities may support each VFL configuration. Additionally or alternatively, one VFL server and/or one VFL client may support multiple VFL configurations.

A VFL server supporting a VFL configuration ID may be configured with the VFL configuration (e.g., the VFL server is configured with information of local ML models with features and/or associated NF types as data source for the supported VFL configuration). The VFL server may be represented by a VFL configuration ID. The supported VFL configuration IDs may be part of the VFL server (either an NWDAF or an AF) NF profile stored in the NRF. When a VFL client supports a VFL configuration ID, VFL clients may align with VFL server about its supported local ML model including input features and/or output features for the VFL configuration.

For example, a network entity and/or application server may store VFL configurations. A VFL server and/or a VFL client may query a VFL configuration based on VFL configuration ID from the network entity and/or an application server.

A VFL server supporting a VFL configuration ID may register with the NRF its supported VFL configuration ID per analytic ID or per ML model and/or analytic ID at the network operator. When the VFL client registers its supported VFL configuration ID at the network operator, the VFL client may also registers NF type. The NF type may be associated to the input features of VFL client's supporting local ML model for the VFL configuration as a data provider. For example, VFL for user service experience prediction, WTRU location (e.g., cell ID and/or tracking area ID) may be used as input feature and/or gathered from WTRU's serving AMF. The AMF may be the associated NF type for WTRU's location information. Deep neural network (DNN) and/or session and service continuity (SSC) mode may be used as input features for the user service experience prediction. DNN and/or SSC may be gathered from the session management function (SMF) managing WTRU's protocol data unit (PDU) session. Therefore, for DNN and SSC mode, the SMF may be the associated NF type.

A VFL server may discover VFL clients supporting VFL configuration ID. The VFL server may select VFL clients based on the supported NF type as a data source for the features so that VFL server may select VFL clients supporting the required features and/or the VFL configuration.

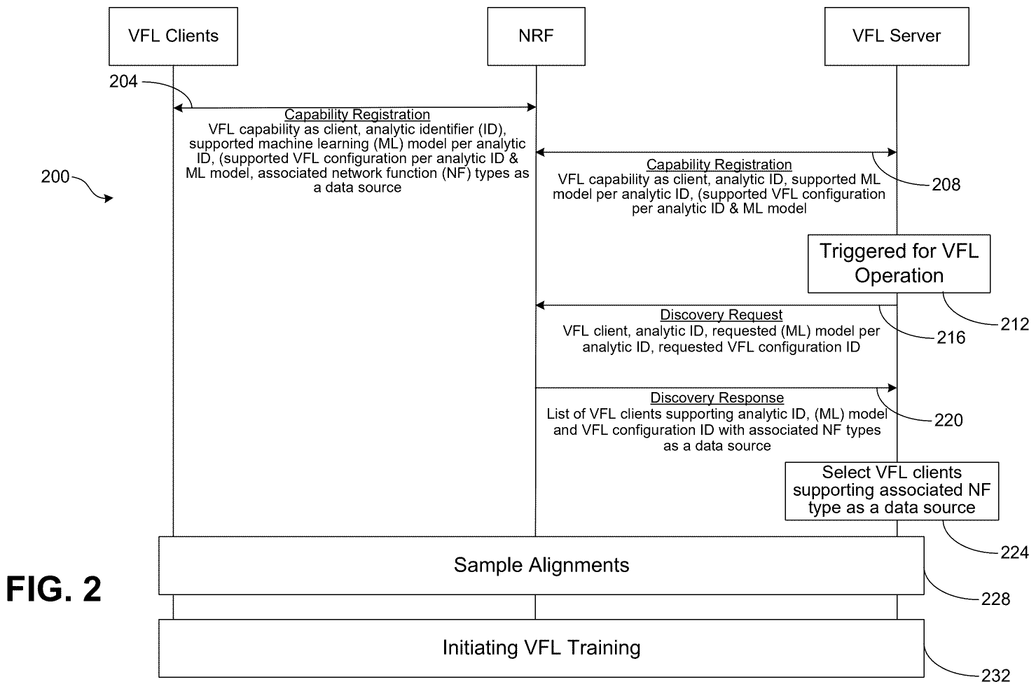

FIG. 2 depicts a callflow 200 of a VFL procedure with VFL clients using a VFL configuration ID. At 204, if NWDAF and/or AF has a capability as a VFL client (which supports an analytic service(s)), and/or is represented by analytic IDs, the NWDAF and/or AF registers with the NRF. Specifically, the NWDAF and/or AF may register its capability at NRF by sending a Capability Registration Request including NF ID, NF type, and/or capability as VFL client with supported analytic ID(s) and/or supported VFL configuration ID(s) with associated NF type per analytic ID at NRF.

The associated NF type(s) of supported VFL configuration ID may be associated with the input feature of the supported local ML model(s) in the VFL configuration represented by VFL configuration ID. The associated NF type(s) may be associated with the sample space required for the relevant VFL operation.

Additionally or alternatively, since different VFL configurations for the same ML model serving an analytic ID can exist, the VFL configuration ID may be unique per analytic ID and/or supported ML model for VFL. The capability registration request from the VFL client may include a supported ML model for VFL. VFL clients may include their service area when their data source is restricted by the service area.

At 208, if NWDAF and/or AF has a capability as a VFL server, (which supports an analytic service(s)) and/or is represented by analytic IDs, the NWDAF and/or AF may register with the NRF. Specifically, the NWDAF and/or NRF may register its capability at NRF by sending a Capability Registration Request including NF ID, NF type, and/or capability as VFL server with supported analytic ID(s) and/or supported VFL configuration ID(s) per analytic ID.

Additionally or alternatively, since different VFL configurations for the same ML model serving an analytic ID can exist, the VFL configuration ID may be unique per analytic ID and/or supported ML model for VFL. The capability registration request from the VFL client may include a supported ML model for VFL. The VFL server may include its service area when VFL server supports VFL with input data from the service area.

At 212, a VFL server may be triggered for VFL (e.g., VFL operation) for an analytic ID and/or ML model. A VFL server may determine a VFL configuration ID for the requested analytic ID and/or ML model. The VFL server may determine a VFL configuration ID based on the operator's policy. The VFL server may further determine a VFL configuration ID on filtering information relevant to a specific analytic ID. For observed service experience analytics, the service consumer may provide single-network slice selection assistance information (S-NSSAI), area of interest and/or application ID. The VFL Server may account for this filter information when selecting the VFL configuration ID. The VFL configuration ID may map to the relevant samples the VFL server wants the VFL clients to use.

At 216, after VFL configuration ID is decided for the requested analytic ID and ML model, VFL server may send discovery request to the NRF to discover VFL clients supporting VFL configuration ID for the analytic ID and ML model. In the discovery request, capability as VFL client, requested analytic ID, requested VFL configuration ID for the requested analytic ID are included. The requested ML model for the requested analytic ID may be included. Upon receiving the request, the NRF may determine the VFL clients supporting the determined analytics ID based on the VFL client information provided in the capability registration. For example, the NRF may compare the supported configuration per analytics ID provided in the capability registration request of VFL clients with the requested VFL configuration ID provided in the discovery request from the VFL server. Additionally, the NRF may consider other parameters for the VFL client discovery, such as supported ML model identifiers.

When analytic service of analytic ID is requested for some specific service area, the requested service area may be included in the discovery request such that only VFL clients that support the service area may be discovered.

At 220, the NRF may send discovery response to the VFL server which include list of VFL clients supporting the requested analytic ID, requested ML model and VFL configuration ID for the requested analytic ID and requested ML model. For each VFL client, an associated NF type(s) as data source may be included to represent input features of the supported local ML model of the VFL configuration ID. Service area information of each VFL client may be included with the list of VFL clients.

At 224, upon receiving the discovery response, the VFL server may select proper VFL clients as candidate VFL clients based on associated NF type(s) as data source and/or other factors (e.g., service area, resource utilization ratio, and/or power consumption ratio, etc.). By selecting VFL clients based on the associated NF type(s) as a data source, the VFL server may select all the required VFL clients to cover input features for VFL configuration. The VFL server may consider the service area information of each VFL client when selecting VFL clients to support VFL operation for some target samples so that the service area of VFL clients cover the target sample's location. The VFL server may further consider input data from the requested service area for the requested analytic ID.

At 228, the VFL server may perform sample alignment with the selected VFL clients. Based on sample alignment result, VFL server may down select VFL clients from candidate VFL clients. Although VFL clients discovered by VFL client through the NRF support the sample space requested by the VFL Server in the discovery request (i.e. as part of the VFL configuration ID), the sample space might have changed after the discovery response is received. Therefore, some VFL clients may be discarded. For example, if some of samples are not available for data collection for the requested features (e.g., because of mobility and/or privacy), those samples may be dropped and/or based on the selected sample and/or service area covering the selected sample. Accordingly, these VFL clients may be down selected.

At 232, the VFL server may initiate VFL training procedure with the selected VFL clients based on VFL configuration ID for the requested analytic ID and ML model.

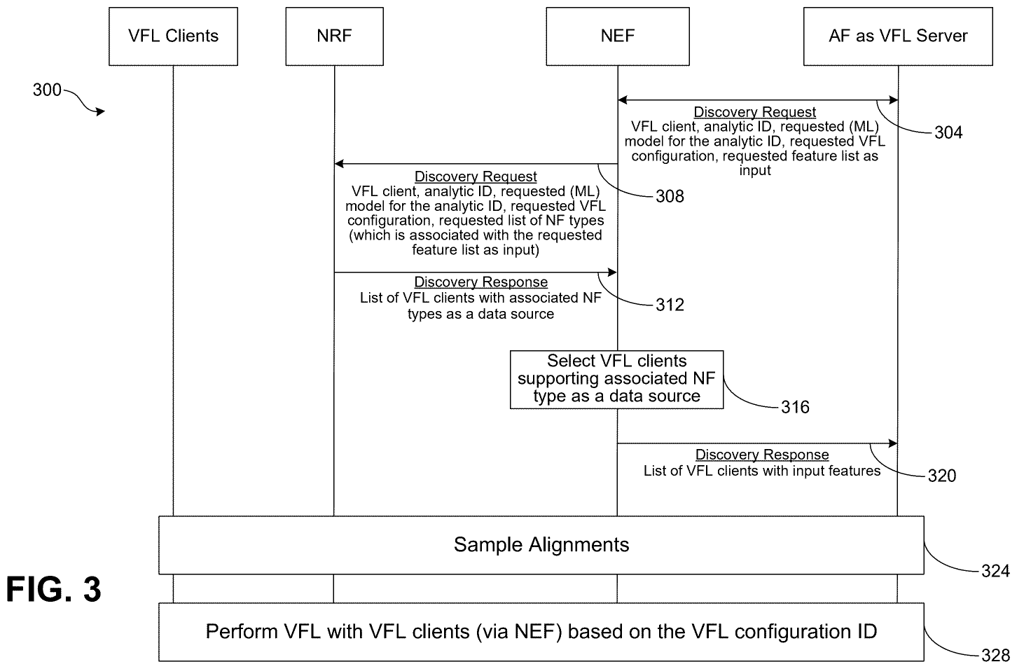

FIG. 3 depicts a callflow 300 of a VFL procedure with an AF as a VFL server using VFL configuration ID. When an AF acts as a VFL server for a VFL configuration, the AF may communicate with a network exposure function (NEF) to perform VFL clients'discovery with the core network for the VFL configuration. In this case, the VFL server (e.g., the AF) may provide the list of features to the NEF. The NEF may perform the VFL clients'selection with associated NF types. The AF, which registered its capability as VFL server for some analytic services and VFL configuration ID for the analytic services, may be triggered for VFL operation for an analytic service.

At 304, an AF may send discovery request to the NEF to verify whether the system supports requested VFL with VFL configuration ID for the requested analytic services. In the discovery request, the AF may include requested VFL configuration ID and/or requested feature list as input for the VFL configuration.

When the analytic service is requested for some specific area, the requested service area may be included in discovery request.

At 308, after receiving discovery request from AF, the NEF may send a discovery request to NRF to discover VFL clients supporting the requested VFL configuration ID for the requested analytic ID. The discovery request may include the capability as VFL client, requested analytic ID, and/or requested VFL configuration ID for the requested analytic ID. The discovery request may further include the requested ML model for the requested analytic ID. If analytic ID is included at the discovery request from AF but requested analytic service information, the NEF may translate the requested analytic service information into a requested analytic ID. The NEF may include the translated analytic ID in the discovery request to NRF. Upon receiving the request, the NRF may determine the VFL clients supporting the determined analytics ID based on the VFL client information provided in the capability registration. For example, the NRF may compare the supported configuration per analytics ID provided in the capability registration request of VFL clients with the requested VFL configuration ID provided in the discovery request from the VFL server. Additionally, the NRF may consider other parameters for the VFL client discovery such as supported ML model identifiers. When the discovery request includes area information, the NEF may translate the area information into service area information supported by system. The NEF may further include the service area information in the discovery request to NRF.

At 312, the NRF may send a discovery response to the NEF which may include a list of VFL clients supporting the requested analytic ID, requested ML model, and/or VFL configuration ID for the requested analytic ID and/or requested ML model. For each VFL clients, associated NF type(s) as data source may be included to represent input features of the supported local ML model of the VFL configuration ID. Service area information of each VFL client may be included along with the list of VFL clients.

At 316, the NEF may select VFL clients among the list of VFL clients which have associated NF type(s) as data source and/or correspond to the requested feature list as input for the VFL configuration. The NEF may consider other factors (e.g., service area, resource utilization ratio, and/or power consumption ratio, etc.) for selection of candidate VFL clients. By selecting VFL clients based on the associated NF type(s) as data source, the NEF may select all the required VFL clients to cover the requested feature list as input for VFL configuration by AF. Service area information of each VFL client may be considered when selecting VFL clients to support VFL operation with input data from the requested area by AF.

In an example, at 308, the NEF may include NF types as a data source. These NEF types may correspond to the list of features from AF in the discovery request to NRF. Based on this NF type information, the NRF may select VFL clients which cover the list of NF type(s) as data source included in discovery request from discovered VFL clients supporting VFL configuration ID. The NRF may include those selected VFL clients'information with associated NF type(s) as data source in the discovery response to NEF.

At 320, the NEF may send a discovery response to AF. The discovery response may include list of VFL clients supporting the requested VFL configuration ID for the requested analytic service with input features.

At 324, the AF may perform sample alignment with the selected VFL clients via NEF. Based on sample alignment result, the VFL server may down select VFL clients from candidate VFL clients. For example, if some of samples are not available for data collection for the requested features (e.g., because of mobility or privacy), those samples may be dropped. Based on the selected sample and service area covering the selected sample, the VFL clients may be down selected.

At 328, the AF may perform vertical federated learning with VFL clients via NEF based on the VFL configuration ID.

1. A vertical federated learning (VFL) server, comprising a processor and a memory, the processor and memory configured to:
send a discovery request to a network repository function (NRF), the discovery request comprising a VFL configuration identifier (ID), wherein a VFL configuration associated with the VFL configuration ID is supported by the VFL server, the discovery request indicating that the VFL server is configured to discover one or more VFL clients, wherein the one or more VFL clients support the VFL configuration ID;
receive a discovery response, the discovery response comprising a list of one or more VFL clients that support the VFL configuration ID;
select one or more VFL clients from the list of one or more VFL clients that support the VFL configuration ID and network function (NF) as a data source; and
perform sample alignment on the selected one or more VFL clients.

2. The VFL server of claim 1, wherein the processor and memory are further configured to:
send a capability registration request to the NRF, wherein the capability registration request comprises the VFL configuration ID and one or more NF types supported by the VFL server; and
receive, from the NRF, a confirmation of receipt of the capability registration request.

3. The VFL server of claim 2, wherein the capability registration request further comprises an indication of the VFL server being capable of performing as a network data analytic function (NWDAF) or as an application function (AF).

4. The VFL server of claim 1, wherein the processor and memory are further configured to:
determine the VFL configuration ID based on an analytic ID and a machine learning (ML) model.

5. The VLF server of claim 4, wherein the VFL configuration ID is further based on one or more of a single-network slice selection assistance information (S-NSSAI), an area of interest of network communication, or an area of interest of network communication mobility.

6. The VFL server of claim 4, wherein the analytic ID is associated with the service area covered by the VFL client.

7. The VFL server of claim 1, wherein the processor and memory are further configured to:
receive, prior to sending the discovery request to the NRF, a request to select one or more VFL clients associated with the analytic ID supported by the VFL server.

8. The VFL server of claim 1, wherein the processor and memory are further configured to:
perform machine learning model training with the selected VFL clients based on the VFL configuration ID.

9. The VFL server of claim 1, wherein the selection of VFL clients is further based on one or more of NF types associated with the VFL server, service area of the network, resource utilization ratio, or power consumption ratio.

10. (canceled)

11. A method implemented by a vertical federated learning (VFL) server, the method comprising:
sending a discovery request to a network repository function (NRF), the discovery request comprising a VFL configuration identifier (ID), wherein a VFL configuration associated with the VFL configuration ID is supported by the VFL server, the discovery request indicating that the VFL server is configured to discover one or more VFL clients, wherein the one or more VFL clients support the VFL configuration ID;
receiving a discovery response, the discovery response comprising a list of one or more VFL clients that support the VFL configuration ID;
selecting one or more VFL clients from the list of one or more VFL clients that support the VFL configuration ID and network function (NF) as a data source; and
performing sample alignment on the selected one or more VFL clients.

12. The method of claim 11, further comprising:
sending a capability registration request to the NRF, wherein the capability registration request comprises the VFL configuration ID and one or more NF types supported by the VFL server; and
receiving, from the NRF, a confirmation of receipt of the capability registration request.

13. The method of claim 12, wherein the capability registration request further comprises an indication of the VFL server being capable of performing as a network data analytic function (NWDAF) or as an application function (AF).

14. The method of claim 11, further comprising:
determining the VFL configuration ID based on an analytic ID and a machine learning (ML) model.

15. The method of claim 14, wherein the VFL configuration ID is further based on one or more of a single-network slice selection assistance information (S-NSSAI), an area of interest of network communication, or an area of interest of network communication mobility.

16. The method of claim 14, wherein the analytic ID is associated with the service area covered by the VFL client.

17. The method of claim 11, further comprising:
receiving, prior to sending the discovery request to the NRF, a request to select one or more VFL clients associated with the analytic ID supported by the VFL server.

18. The method of claim 11, further comprising:
performing machine learning model training with the selected VFL clients based on the VFL configuration ID.

19. The method of claim 11, wherein the selection of VFL clients is further based on one or more of NF types associated with the VFL server, service area of the network, resource utilization ratio, or power consumption ratio.

20. (canceled)

21. The VFL server of claim 1, wherein the selected one or more VFL clients from the list of one or more VFL clients support the VFL configuration ID and support the one or more NFs as a data source, wherein the one or more selected VFL clients are associated with the one or more NFs as a data source.

22. The method of claim 11, wherein the selected one or more VFL clients from the list of one or more VFL clients support the VFL configuration ID and support the one or more NFs as a data source, wherein the one or more selected VFL clients are associated with the one or more NFs as a data source.
